(19) United States
(12) Patent Application Publication
(10) Pub. No.: US 2020/0045166 A1
(43) Pub. Date: Feb. 6, 2020

(54) ACOUSTIC SIGNAL PROCESSING DEVICE, ACOUSTIC SIGNAL PROCESSING METHOD, AND HANDS-FREE COMMUNICATION DEVICE

(71) Applicant: Mitsubishi Electric Corporation, Tokyo (JP)

(72) Inventor: Satoru FURUTA, Tokyo (JP)

(73) Assignee: Mitsubishi Electric Corporation, Tokyo (JP)

(21) Appl. No.: 16/479,162

(22) PCT Filed: Mar. 8, 2017
(86) PCT No.: PCT/JP2017/009275

§ 371 Date: Jul. 18, 2019

(51) Int. Cl. H04M 3/00; H04M 1/60; G10L 21/0232; G10L 25/24; G10L 21/02

(52) U.S. Cl. CPC H04M 3/002; H04M 1/6041; G10L 2021/02082; G10L 25/24; G10L 21/0205; G10L 21/0232

(57) ABSTRACT

An acoustic signal processing device includes an acoustic signal analysis unit that analyzes an acoustic feature of a reception signal from a far end side and thereby generates an appropriate control signal, an echo canceller that cancels an acoustic echo mixed into an input acoustic signal, a noise canceller that cancels noise mixed into the input acoustic signal, and a speech enhancement unit that enhances a feature of speech included in the input acoustic signal, and thus high speech quality can be maintained irrespective of the type of a mobile phone or a communication network, and a high-quality hands-free voice call and high-accuracy speech recognition become possible.

### TECHNICAL FIELD

The present invention relates to an acoustic signal processing device, an acoustic signal processing method and a hands-free communication device that realize comfortable voice intercommunication and high-accuracy speech recognition in a voice communication system in which voice intercommunication is performed via a communication network.

### BACKGROUND ART

With the progress of digital signal processing technology in recent years, hands-free voice calls in automobiles and hands-free operations by means of speech recognition have become widespread. In such hands-free functions in automobiles, voice uttered by a person in an automobile (transmission voice) is collected by a microphone, the collected voice is transmitted to the party of a call via a mobile phone or a communication network in cases of a voice call, the collected voice is transmitted to a computer for speech recognition in cases of speech recognition. Further, voice uttered by the party of the call or voice outputted by the computer (referred to as reception voice) is similarly outputted to the inside of the automobile from a speaker via the mobile phone or the communication network.

Such calls and operations are performed in many cases in an environment with high levels of acoustic echo and noise in which traveling noise of the vehicle or an acoustic signal generated by an audio speaker or the like (acoustic echo) rebounds into the microphone a lot, and thus not only a speech signal uttered by a speaker but also unnecessary signals such as background noise and acoustic echoes are inputted to the microphone, leading to deterioration in the communication voice and a drop in the speech recognition rate. Therefore, this type of hands-free communication devices are conventionally provided with an echo canceller for canceling the acoustic echo and a noise canceller for suppressing noise such as traveling noise of a vehicle.

However, in the conventional hands-free communication devices described above, values of parameters for controlling the echo canceller and the noise canceller have been set at certain values adjusted at the time of designing the device so as to realize an appropriate operation. Thus, depending on the type of the mobile phone connected to the hands-free communication device or the type of the communication network used, there are cases where the echo canceller and the noise canceller cannot sufficiently deliver their performance due to a difference in a voice coding method used for compressing audio data in the mobile phone or a difference in a transmission signal level in the communication network, an acoustic echo or noise remains in the transmission voice or a feeling of destruction of the communication voice occurs due to excessive suppression of the transmission voice, and consequently, prescribed sound quality of the call presumed at the time of design or the like cannot be maintained.

Therefore, to realize a comfortable voice call and high-accuracy speech recognition, there is required an acoustic signal processing device capable of correcting the transmission voice by absorbing the difference in the voice coding method, the communication network, etc. depending on the type of the mobile phone connected to the hands-free communication device or the type of the communication network used.

As methods for the aforementioned correction of the transmission voice, there exist conventional methods using the type, the phone number or the like of the connected mobile phone (e.g., Patent Reference 1 and Patent Reference 2), for example. These conventional methods maintain quality of the transmission voice by changing the contents of acoustic processing of the transmission signal depending on information on a prescribed phone number and information on the connected mobile phone.

### PRIOR ART REFERENCE

### Patent Reference

Patent Reference 1: Japanese Patent Application Publication No. 2000-165488 (see paragraphs 0063 to 0067, for example)

Patent Reference 2: Japanese Patent Application Publication No. 2001-268212 (see paragraphs 0021 to 0046, for example)

### SUMMARY OF THE INVENTION

### Problem to be Solved by the Invention

However, in cases of an anonymous call where the party's phone number cannot be acquired, in cases where a mobile phone employing a new voice coding method appears in the future, and so forth, no ID for identification such as a phone number is provided, and thus the conventional methods described in the Patent Reference 1 and the Patent Reference 2 have a problem in that correctly performing the acoustic signal processing becomes impossible due to impossibility of making a clear distinction, and consequently, the sound quality of the transmission voice deteriorates and the accuracy of the speech recognition drops.

An object of the present invention, which has been made to resolve the above-described problems, is to provide an acoustic signal processing device, an acoustic signal processing method and a hands-free communication device capable of maintaining high quality of communication voice even in situations in which no ID for identification such as a phone number is provided.

### Means for Solving the Problem

An acoustic signal processing device according to an aspect of the present invention includes: an acoustic signal analysis unit that analyzes an acoustic feature of a first acoustic signal of reception voice inputted from a far end side and generates a control signal for correcting a second acoustic signal of transmission voice inputted from a near end side according to result of the analysis; and an acoustic signal correction unit that makes a correction of the second acoustic signal based on the control signal.

An acoustic signal processing method according to another aspect of the present invention includes: an acoustic signal analysis step of analyzing an acoustic feature of a first acoustic signal of reception voice inputted from a far end side and generating a control signal for correcting a second acoustic signal of transmission voice inputted from a near end side according to result of the analysis; and an acoustic signal correction step of making a correction of the second acoustic signal based on the control signal.

A hands-free communication device according to another aspect of the present invention includes: the aforementioned acoustic signal processing device; an analog-to-digital conversion unit that performs analog-to-digital conversion on the second acoustic signal and thereby generates a digital signal; and a digital-to-analog conversion unit that performs digital-to-analog conversion on the first acoustic signal and thereby generates an analog signal.

### Effect of the Invention

According to the present invention, even in situations in which no ID for identification such as a phone number is provided, high speech quality can be maintained and consequently a high-quality hands-free voice call and high-accuracy speech recognition become possible.

### BRIEF DESCRIPTION OF THE DRAWINGS

FIG. 1 is a diagram showing a general configuration of a hands-free communication device according to a first embodiment of the present invention.

FIG. 2 is a diagram showing a general configuration of an acoustic signal analysis unit in the first embodiment.

FIG. 3 is a block diagram showing an example of a hardware configuration of the hands-free communication device according to the first embodiment.

FIG. 4 is a block diagram showing another example of the hardware configuration of the hands-free communication device according to the first embodiment.

FIG. 5 is a flowchart showing a part of operation of the hands-free communication device according to the first embodiment.

FIG. 6 is a diagram showing a general configuration of an acoustic signal processing device according to a second embodiment of the present invention.

### MODE FOR CARRYING OUT THE INVENTION

Modes for carrying out the present invention will be described below with reference to the accompanying drawings in order to explain the present invention in more detail. In the following description, a person who directly sends voice to a hands-free communication device according to embodiments will be referred to as a near end-side speaker, and a person who is the party talking with the near end-side speaker and sends voice to the hands-free communication device according to the embodiments via a communication network will be referred to as a far end-side speaker. An acoustic signal processing device described below is a device capable of implementing acoustic signal processing among the functions of the hands-free communication device. The acoustic signal processing device is a device capable of implementing an acoustic signal processing method.

### (1) First Embodiment

### (1-1) Configuration

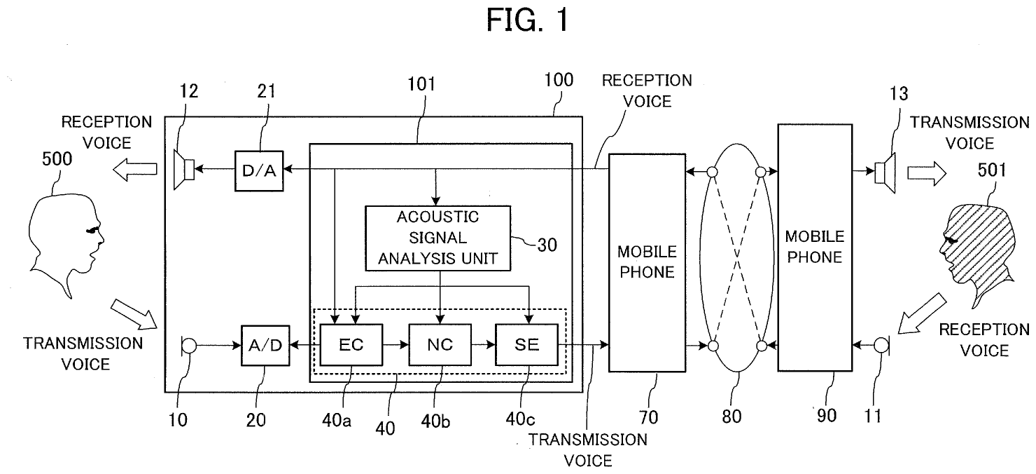

FIG. 1 is a diagram showing the general configuration of a hands-free communication device 100 according to a first embodiment of the present invention. The hands-free communication device 100 is a device performing voice communication between a near end-side speaker 500 and a far end-side speaker 501. As shown in FIG. 1, the hands-free communication device 100 includes an acoustic signal processing device 101, a microphone 10, a speaker 12, an analog-to-digital conversion unit 20 and a digital-to-analog conversion unit 21. The acoustic signal processing device 101 includes an acoustic signal analysis unit 30 and an acoustic signal correction unit 40. The acoustic signal correction unit 40 includes an echo canceller 40a, a noise canceller 40b and a speech enhancement unit 40c.

As shown in FIG. 1, the hands-free communication device 100 is connected to a mobile phone 70. The mobile phone 70 is a mobile phone carried by the near end-side speaker 500. As shown in FIG. 1, the mobile phone 70 is connected to a mobile phone 90 via a communication network 80. The mobile phone 90 is a mobile phone carried by the far end-side speaker 501.

The hands-free communication device 100 in FIG. 1 is shown as an example of the hands-free communication device 100 installed in a car navigation system of an automobile. Incidentally, the hands-free communication device 100 is not limited to the installation in the car navigation system of the automobile; the hands-free communication device 100 may be installed in a different type of vehicle such as a train or an airplane, for example.

FIG. 1 shows a case where a user (near end-side speaker 500) in a traveling automobile performs voice intercommunication with a party (far end-side speaker 501). In FIG. 1, the near end-side speaker 500 is making a hands-free call in the automobile, while the far end-side speaker 501 is making the call with the mobile phone in hand.

To simplify the explanation, illustration in this patent specification is limited to the hands-free call function while leaving out the other functions of the car navigation system of the automobile. Here, the voice uttered by the near end-side speaker 500 is defined as transmission voice and the voice uttered by the far end-side speaker 501 is defined as reception voice.

An input to the hands-free communication device 100 includes not only the transmission voice of the near end-side speaker 500 picked up by the microphone 10 but also noise such as the traveling noise of the automobile, the reception voice of the far end-side speaker 501 outputted from the speaker 12, guidance voice outputted from the car navigation system, an acoustic echo of music or the like from a car audio system, and so forth, which will be collectively referred to as an input acoustic signal.

Another input to the hands-free communication device 100 is the reception voice of the far end-side speaker 501 outputted from the mobile phone 70. The mobile phone 70 performs voice communication by connecting to the car navigation system by wire, via a wireless Local Area Network (LAN), or via short-range wireless communication such as Bluetooth (registered trademark).

In the example of FIG. 1, the voice communication between the mobile phone 70 and the hands-free communication device 100 is assumed to be processed by use of digital signals, wherein analog-to-digital conversion is left out. The reception voice is inputted through a microphone 11 of the mobile phone 90 carried by the far end-side speaker 501 and transmitted via the communication network 80 to the mobile phone 70 connected to the hands-free communication device 100.

The configuration of the hands-free communication device 100 in the first embodiment and its principle of operation will be described below with reference to FIG. 1. The analog-to-digital conversion unit 20 performs analog-to-digital conversion on the aforementioned input acoustic signal, samples the signal at a prescribed sampling frequency (e.g., 8 kHz), and converts the signal into a digital signal partitioned in units of frames (e.g., 20 ms). The input acoustic signal converted into the digital signal is inputted to the echo canceller 40a.

The acoustic signal analysis unit 30 analyzes an acoustic feature of a reception signal as a first acoustic signal of the reception voice uttered by the far end-side speaker 501 and outputs a control signal D3, for correcting the input acoustic signal as a second acoustic signal of the transmission voice, according to the result of the analyzing. The control signal D3 is a signal for controlling the acoustic signal correction unit 40 (the echo canceller 40a, the noise canceller 40b and the speech enhancement unit 40c). Detailed operation of the acoustic signal analysis unit 30 will be described later.

The echo canceller (EC: Echo Canceller) 40a inputs the input acoustic signal and the reception signal inputted to the hands-free communication device 100 and cancels the acoustic echo mixed into the input acoustic signal. The cancellation of the acoustic echo by the echo canceller 40a can be carried out by means of a publicly known method using an adaptive filter, such as the nounalized Least Mean Square (LMS) method. Incidentally, the reception signal is used for the learning of filter coefficients of the adaptive filter. The input acoustic signal after undergoing the acoustic echo cancellation is inputted to the noise canceller 40b.

The noise canceller (NC: Noise Canceller) 40b cancels noise mixed into the input acoustic signal. For the noise cancellation by the noise canceller 40b, after converting the input acoustic signal into a spectrum in the frequency domain by means of Fast Fourier Transform (FFT) or the like, it is possible to employ the spectral subtraction method, as well as publicly known methods by power spectrum control such as the Minimum Mean Square Error (MMSE) estimation method and the Maximum a Posteriori (MAP) estimation method. Besides the methods in the frequency domain, it is also possible to employ a method in the time domain such as the Wiener filter method.

The speech enhancement unit (SE: Speech Enhancement) 40c is a processing unit that performs an enhancement process on the speech included in the input acoustic signal in regard to parts whose feature is desired to be enhanced and expressed. For the speech enhancement process in this embodiment, it is possible to employ, for example, formant enhancement which is used to enhance the so-called formant as an important peak component (component having a high spectrum amplitude) of the speech spectrum.

As an example of the method of the formant enhancement, an autocorrelation coefficient is obtained from a Hanning windowed speech signal, a bandwidth expansion process is performed, thereafter a twelfth order linear prediction coefficient is obtained by the Levinson-Durbin method, and a formant enhancement coefficient is obtained from the linear prediction coefficient.

Then, the formant enhancement can be carried out by applying a synthesis filter of the Auto Regressive Moving Average (ARMA) type using the obtained formant enhancement coefficient. The method of the formant enhancement is not limited to the above-described method; other publicly known methods may be used.

Besides the above-described speech enhancement process, the speech enhancement unit 40c may employ various publicly known speech enhancement processes, such as a process of emphasizing harmonic structure of voice like pitch emphasis and an equalizer process of changing the frequency characteristics of the transmission signal, as well as employing Auto Gain Control (AGC) for adaptively regulating the audio signal level.

The transmission voice after undergoing the speech enhancement process described above is outputted to the mobile phone 70, the mobile phone 70 transmits the transmission voice to the mobile phone 90 on the far end side as the party via the communication network 80, and the mobile phone 90 outputs the transmission voice to the far end-side speaker 501 through a receiver 13.

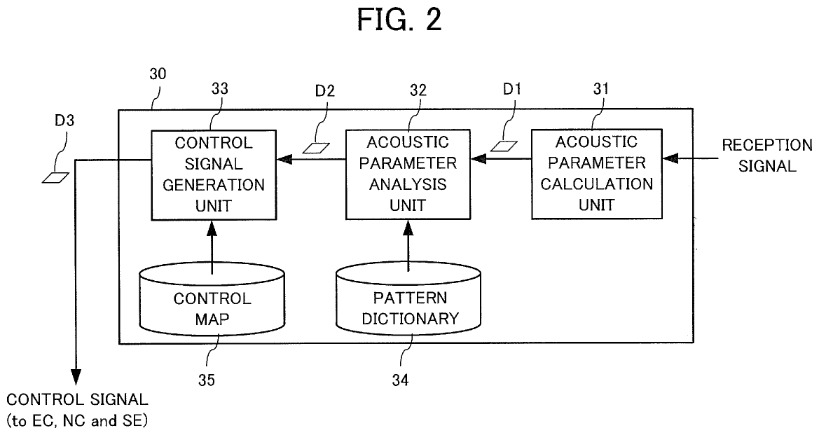

Next, an example of the operation of the aforementioned acoustic signal analysis unit 30 will be described below with reference to FIG. 2. As shown in FIG. 2, the acoustic signal analysis unit 30 is formed of an acoustic parameter calculation unit 31, an acoustic parameter analysis unit 32, a control signal generation unit 33, a pattern dictionary 34 and a control map 35. As shown in FIG. 2, the reception signal according to the reception voice is inputted to the acoustic parameter calculation unit 31.

The acoustic parameter calculation unit 31 performs a windowing process on the inputted current frame of the reception signal, thereafter calculates an N-th order Mel Frequency Cepstrum Coefficient (MFCC) by means of cepstrum analysis, for example, and outputs the N-th order MFCC to the acoustic parameter analysis unit 32 as an analytic acoustic parameter D1. Here, N is a positive integer.

Incidentally, the cepstrum analysis is a publicly known method and thus explanation thereof is omitted here. An appropriate example of the order of MFCC is N=16; however, the order can be changed properly depending on the frequency characteristics of the reception signal or the like.

The acoustic parameter analysis unit 32 refers to the pattern dictionary 34 as a first storage unit, performs matching between MFCC data (first reference data) in the pattern dictionary 34 and the analytic acoustic parameter D1 inputted thereto, and outputs a result giving the shortest Euclidean distance, for example, to the control signal generation unit 33 as a parameter analysis result D2 corresponding to the acquired MFCC data.

The pattern dictionary 34 is a database in which multiple pieces of MFCC data, previously learned and clustered by using a wide variety and a great amount of acoustic signal data, are associated with recognition numbers regarding learning time conditions.

The control signal generation unit 33 refers to reference data (second reference data) in the control map 35 as a second storage unit and generates the control signal D3 for controlling each of the echo canceller 40a, the noise canceller 40b and the speech enhancement unit 40c. For example, when it is inferred that the mobile phone 90 used on the far end side employs Code Division Multiple Access (CDMA) as the result of analyzing the reception voice, the control signal generation unit 33 selects a control signal D3 for echo cancellation, noise cancellation and speech enhancement in CDMA from a plurality of control patterns in the control map 35 and outputs the selected control signal D3.

For example, the control signal generation unit 33 generates a control signal D3 for strengthening the speech enhancement process and an echo suppression amount in the echo cancellation process while weakening a noise suppression amount in the noise cancellation process. Specifically, the control signal generation unit 33 generates a control signal D3 for intensifying the maximum value of a residual echo suppression amount of the echo canceller 40a from 20 dB to 40 dB and augmenting the formant enhancement coefficient as one of the speech enhancement processes from 0.2 to 0.4 while relaxing the maximum value of the noise suppression amount of the noise canceller 40b from 12 dB to 3 dB.

By performing the control described above, destabilization of CDMA voice coding due to residual echo components included in the transmission signal is inhibited, the voice coding efficiency is increased through great enhancement of a speech feature in the transmission voice, and consequently, a high-quality call becomes possible.

Another advantage is obtained as follows: While a noise cancellation process separate from the hands-free communication device 100 has been introduced into a voice coding algorithm of the CDMA, excessive noise cancellation occurs in conventional methods due to double processing by the noise cancellation process in the hands-free communication device 100 and the noise cancellation process in the CDMA, resulting in an increased feeling of speech destruction. In contrast, by performing the control according to this embodiment, the noise cancellation is controlled at an appropriate noise cancellation amount, by which the speech destruction feeling is eliminated, maintaining high speech quality becomes possible, and a high-quality voice call can be carried out.

Besides the control described above, it is possible to perform control of stopping the noise cancellation process in the hands-free communication device 100 in cases where it is inferred that both of the mobile phones 70 and 90 on the near end side and the far end side employ CDMA, it is inferred that a noise cancellation process is performed in the communication network even though the communication method is unknown, or the like, for example.

Further, in cases where it is inferred that there is a lot of voice discontinuity feeling, namely, there are a lot of transmission errors in the communication network, as the result of analyzing the reception voice, it is possible to perform control for intensifying the speech enhancement. Like these processes, it is possible to control the noise cancellation process and the speech enhancement process by sorting out various conditions based on the reception signal.

While the maximum value of the residual echo suppression amount of the echo canceller 40a is intensified from 20 dB to 40 dB and the formant enhancement coefficient as one of the speech enhancement processes is intensified from 0.2 to 0.4 while relaxing the maximum value of the noise suppression amount of the noise canceller 40b from 12 dB to 3 dB as an example of the control of the processing by the echo canceller 40a, the noise canceller 40b and the speech enhancement unit 40c, the control is not limited to this example; the control may be changed properly depending on a factor such as the frequency characteristics or the input level of the microphone for collecting the input acoustic signal, for example.

Incidentally, while the acoustic parameter calculation unit 31 in the above-described embodiment uses the MFCC as the analytic acoustic parameter, the analytic acoustic parameter is not limited to this example; it is also possible, for example, to additionally use a parameter well representing a feature of the voice, such as an autocorrelation coefficient or a power spectrum obtained by FFT.

While a method by means of pattern matching is used by the acoustic parameter analysis unit 32 in the acoustic signal analysis unit 30 in the above-described embodiment, the method is not limited to this example; it is also possible to use a method based on machine learning instead of using the acoustic parameter analysis unit 32 and the pattern dictionary 34.

As the method based on machine learning, it is possible to use an identification method based on support vector machine (SVM), AdaBoost or the like, or a neural network, for example.

As the method based on a neural network, it is possible to use, for example, a derivative and improved type of a publicly known neural network, such as Recurrent Neural Network (RNN) that returns a part of the output signal to the input or Long Short-Term Memory (LSTM)-RNN obtained by improving coupling element structure of RNN.

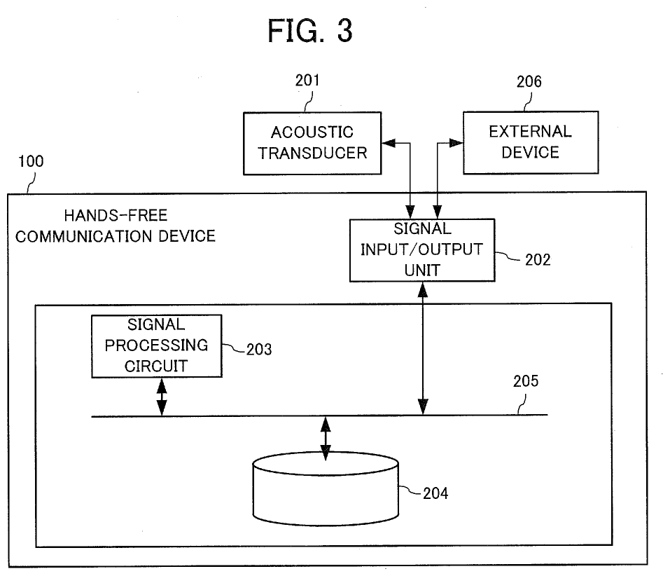

FIG. 3 is a block diagram showing an example of the hardware configuration of the hands-free communication device 100 according to the first embodiment. The hardware configuration of the hands-free communication device 100 in the first embodiment can be implemented by a Large Scale Integrated circuit (LSI) such as a Digital Signal Processor (DSP), an Application Specific Integrated Circuit (ASIC) or a Field-Programmable Gate Array (FPGA).

As shown in FIG. 3, the hardware of the hands-free communication device 100 according to the first embodiment is formed of a signal input/output unit 202, a signal processing circuit 203, a record medium 204, and a signal line 205 such as a bus, for example. Further, as shown in FIG. 3, the hands-free communication device 100 is connected to an acoustic transducer 201 and an external device 206.

The signal input/output unit 202 is an interface circuit that implements a function of connecting to the acoustic transducer 201 and the external device 206. As the acoustic transducer 201, it is possible to use a device that captures acoustic vibration and transduces the acoustic vibration into an electric signal, such as a microphone, and a device that transduces an electric signal into acoustic vibration, such as a speaker, for example.

The functions of the acoustic signal analysis unit 30, the echo canceller 40a, the noise canceller 40b and the speech enhancement unit 40c shown in FIG. 1 can be implemented by the signal processing circuit 203 and the record medium 204. The analog-to-digital conversion unit 20 and the digital-to-analog conversion unit 21 in FIG. 1 correspond to the signal input/output unit 202.

The record medium 204 is used for accumulating various types of data such as signal data or various setting data of the signal processing circuit 203. As the record medium 204, a volatile memory such as a Synchronous DRAM (SDRAM) or a nonvolatile memory such as a Hard Disk Drive (HDD) or a Solid State Drive (SSD) can be used, for example.

The record medium 204 can store data regarding the initial states of the echo canceller 40a, the noise canceller 40b and the speech enhancement unit 40c, various setting data, control map data, pattern dictionary data, and so forth.

The transmission signal after undergoing the acoustic signal processing by the signal processing circuit 203 is sent out to the external device 206 via the signal input/output unit 202. The external device 206 corresponds to the mobile phone 70 connected to the hands-free communication device 100 in FIG. 1. Meanwhile, the reception signal outputted from the mobile phone 70 is inputted to the signal processing circuit 203 via the signal input/output unit 202.

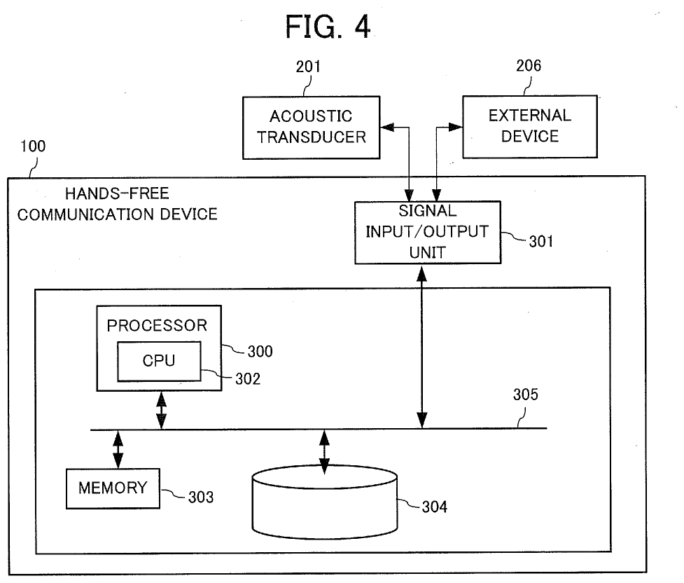

FIG. 4 is a block diagram showing another example of the hardware configuration of the hands-free communication device 100 according to the first embodiment. As shown in FIG. 4, the hardware configuration of the hands-free communication device 100 according to the first embodiment can be implemented by a computer including a Central Processing Unit (CPU), such as a portable computer of the tablet type, a microcomputer to be embedded in a device like a car navigation system, or the like.

As shown in FIG. 4, the hardware of the hands-free communication device 100 according to the first embodiment is folioed of a signal input/output unit 301, a processor 300 including a CPU 302, a memory 303, a record medium 304, and a signal line 305 such as a bus, for example.

The signal input/output unit 301 is an interface circuit that implements a function of connecting to the acoustic transducer 201 and the external device 206. The memory 303 is a storage means such as a ROM or a RAM, to be used as a program memory storing various programs for implementing a hands-free communication process in this embodiment, a work memory used when the processor performs data processing, a memory for spreading signal data, and so forth.

The functions of the acoustic signal analysis unit 30, the echo canceller 40a, the noise canceller 40b and the speech enhancement unit 40c shown in FIG. 1 can be implemented by the processor 300, the memory 303 and the record medium 304. The analog-to-digital conversion unit 20 and the digital-to-analog conversion unit 21 in FIG. 1 correspond to the signal input/output unit 301.

The record medium 304 is used for accumulating various types of data such as signal data or various setting data of the processor 300. As the record medium 304, a volatile memory such as an SDRAM or a nonvolatile memory such as an HDD or an SSD can be used, for example.

The record medium 304 can accumulate programs including an Operating System (OS) and various types of data such as various setting data and acoustic signal data. Incidentally, the data in the memory 303 may also be accumulated in the record medium 304.

The processor 300 is capable of performing signal processing equivalent to the acoustic signal analysis unit 30, the echo canceller 40a, the noise canceller 40b and the speech enhancement unit 40c by using the RAM in the memory 303 as a work memory and operating according to a computer program loaded from the ROM in the memory 303.

The transmission signal after undergoing the acoustic signal processing by the processor 300 is sent out to the external device 206 via the signal input/output unit 301. The external device 206 corresponds to the mobile phone 70 connected to the hands-free communication device 100 in FIG. 1. Meanwhile, the reception signal outputted from the mobile phone 70 is inputted to the processor 300 via the signal input/output unit 301.

The programs implementing the hands-free communication device 100 in this embodiment may either be previously stored in a storage device in the computer executing software programs or distributed through a storage medium such as a CD-ROM.

It is also possible to acquire the programs from another computer via a wireless or wired network such as a LAN. Further, various types of data may be transmitted and received via a wireless or wired network also in regard to the acoustic transducer 201 or the external device 206 connected to the hands-free communication device 100 in this embodiment.

### (1-2) Operation

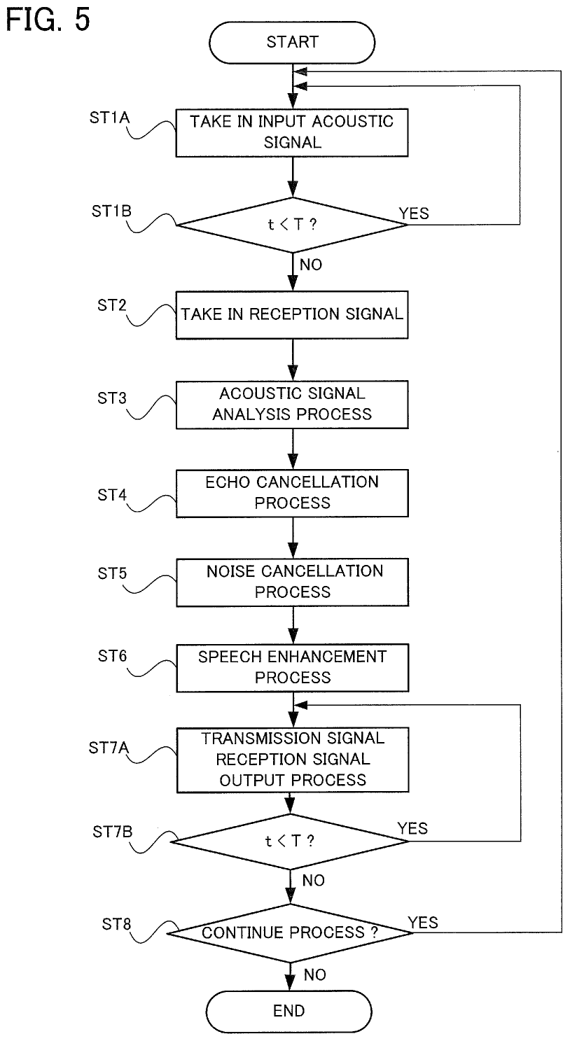

Next, the operation of each part of the hands-free communication device 100 will be described below with reference to a flowchart of FIG. 5. FIG. 5 is a flowchart showing a part of the operation of the hands-free communication device 100 according to the embodiment. As shown in FIG. 5, the analog-to-digital conversion unit 20 takes in the input acoustic signal at prescribed frame intervals (step ST1A) and outputs the input acoustic signal to the echo canceller 40a.

Subsequently, in step ST1B, the echo canceller 40a compares a sample number t with a prescribed value T, and when the sample number t is smaller than the prescribed value T (YES in the step ST1B), the process returns to the step ST1A and the processing of the step ST1A is repeated until the sample number t reaches t=160.

When the sample number t is larger than or equal to the prescribed value T (NO in the step ST1B), the process advances to step ST2 and the acoustic signal analysis unit 30 takes in the reception signal of the reception voice uttered by the far end-side speaker 501 (step ST2).

Subsequently, the process advances to step ST3 and the acoustic signal analysis unit 30 analyzes the acoustic feature of the reception voice uttered by the far end-side speaker 501 and outputs the control signal for controlling each of the echo canceller 40a, the noise canceller 40b and the speech enhancement unit 40c described later according to the result of the analyzing (step ST3).

Subsequently, the process advances to step ST4 and the echo canceller 40a inputs the input acoustic signal and the reception signal inputted to the hands-free communication device 100 and performs the echo cancellation process for canceling the acoustic echo mixed into the input acoustic signal (step 4).

Thereafter, the process advances to step ST5 and the noise canceller 40b performs the noise cancellation process for canceling the noise mixed into the input acoustic signal (step ST5).

Thereafter, the process advances to step ST6 and the speech enhancement unit 40c performs the enhancement process on the speech included in the input acoustic signal in regard to parts well representing a feature of the speech (step ST6).

Subsequently, the process advances to step ST7A and the digital-to-analog conversion unit 21 performs a process of outputting the reception signal to the outside of the hands-free communication device (step ST7A) while also outputting the transmission signal.

Subsequently, the process advances to step ST7B and comparison is made between a sample number t and a prescribed value T. When the sample number t is smaller than the prescribed value T (YES in the step ST7B), the process returns to the step ST7A and the processing of the step ST7A is repeated until the sample number t reaches t=160.

Thereafter, the process advances to step ST8 and the process returns to the step ST1A when the hands-free communication process is continued (YES in the step ST8). Conversely, when the hands-free communication process is not continued (NO in the step ST8), the hands-free communication process is ended.

### (1-3) Effect

As described above, the hands-free communication device 100 according to the first embodiment includes the acoustic signal analysis unit 30 that analyzes an acoustic feature of the reception signal from the far end side and thereby generates an appropriate control signal, the echo canceller 40a that cancels the acoustic echo mixed into the input acoustic signal, the noise canceller 40b that cancels the noise mixed into the input acoustic signal, and the speech enhancement unit 40c that enhances a feature of the speech included in the input acoustic signal. With this configuration, high speech quality can be maintained and a high-quality voice call becomes possible even in situations where no ID for identification such as a phone number is provided.

Specifically, destabilization of CDMA voice coding due to residual echo components included in the transmission signal is inhibited, the voice coding efficiency is increased through great enhancement of a speech feature in the transmission voice, and consequently, a high-quality call becomes possible.

Further, since a noise cancellation process separate from the hands-free communication device has been introduced into the voice coding algorithm of the CDMA in conventional technologies, excessive noise cancellation occurs due to the double processing by the noise cancellation process in the hands-free communication device and the noise cancellation process in the CDMA system, resulting in an increased feeling of speech destruction.

In contrast, with the hands-free communication device 100 according to the first embodiment, the noise cancellation process is not performed twofold, and thus the noise cancellation is controlled at an appropriate noise cancellation amount, by which the speech destruction feeling is eliminated and it becomes possible to maintain high speech quality and carry out a high-quality voice call.

### (2) Second Embodiment

While a case where the far end side is the far end-side speaker 501 as a human making a voice call is described as an example in the first embodiment, the configuration of the present invention is applicable also to cases where the far end side is replaced with a speech recognition device, and such a case will be described below as a second embodiment.

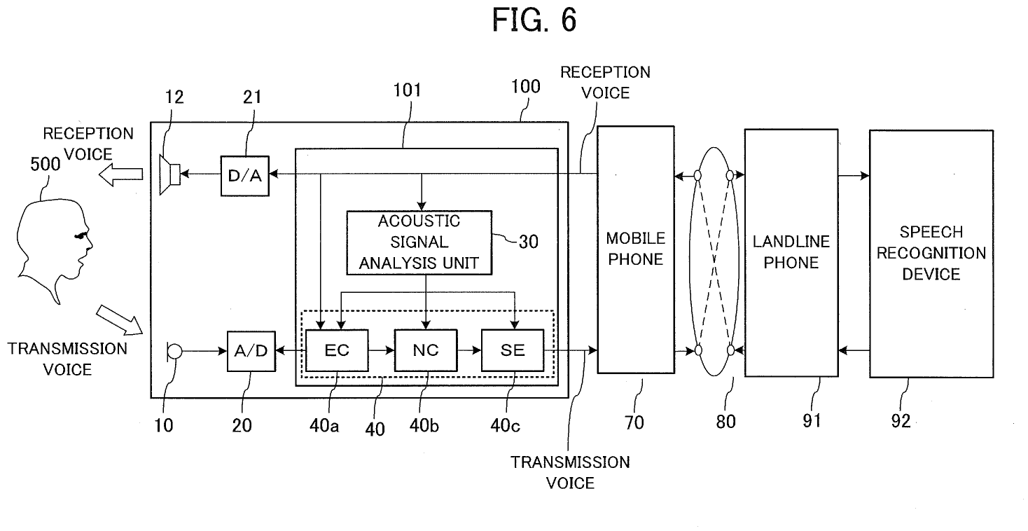

FIG. 6 shows the general configuration of an acoustic signal processing device 101 according to the second embodiment of the present invention. In FIG. 6, the acoustic signal processing device 101 differs from the device in the first embodiment shown in FIG. 1 in that the acoustic signal processing device 101 is connected to a landline phone 91 and a speech recognition device 92 via the communication network 80. The rest of the configuration is the same as that in the first embodiment and thus explanation thereof is omitted by assigning the same reference characters to corresponding components.

The acoustic signal analysis unit 30, the echo canceller 40a, the noise canceller 40b and the speech enhancement unit 40c respectively perform the same processes as those described in detail in the first embodiment, and the transmission voice is transmitted to the landline phone 91 through the mobile phone 70 and the communication network 80. The transmission voice received by the landline phone 91 is transmitted to the speech recognition device 92.

The speech recognition device 92 performs the recognition of the speech included in the transmission signal of the transmission voice received by the landline phone 91, converts the speech recognition result into synthetic voice by using a publicly known text-to-speech (TTS: Text To Speech) conversion process, and transmits the synthetic voice to the mobile phone 70 through the landline phone 91 and the communication network 80 as the reception voice. Incidentally, the process based on the obtained speech recognition result is a component separate from the present invention and thus explanation thereof is omitted here. Further, the landline phone 91 does not necessarily have to be a landline phone; a mobile phone may be used instead.

With the acoustic signal processing device 101 in the second embodiment configured as above, high-accuracy speech recognition becomes possible since high quality of the transmission voice can be maintained irrespective of the type of the mobile phone or the communication network.

As described above, the acoustic signal processing device 101 in the second embodiment includes the acoustic signal analysis unit 30 that analyzes an acoustic feature of the reception signal from the far end side and thereby generates an appropriate control signal, the echo canceller 40a that cancels the acoustic echo mixed into the input acoustic signal, the noise canceller 40b that cancels the noise mixed into the input acoustic signal, and the speech enhancement unit 40c that enhances a feature of the speech included in the input acoustic signal, and thus high transmission voice quality can be maintained even in situations where no ID for identification such as a phone number is provided. Accordingly, speech easily recognizable on the side of the speech recognition device 92 can be transmitted and it is possible to perform high-accuracy speech recognition.

### (3) Modifications

While examples of the hands-free communication device 100 and the acoustic signal processing device 101 installed in a car navigation system have been described in the above embodiments, the hands-free communication device 100 and the acoustic signal processing device 101 are not limited to such examples; the hands-free communication device 100 and the acoustic signal processing device 101 are applicable also to emergency call interphones of elevators or the like, interphones of ordinary households or offices, loudspeaker conversation of TV conference systems, speech recognition dialogue systems of robots, and so forth, for example, and the advantages described in the embodiments are achieved similarly also for noise or acoustic echoes occurring in these acoustic environments.

While the audio signal processing such as the echo cancellation process by the echo canceller 40a, the noise cancellation process by the noise canceller 40b and the speech enhancement process by the speech enhancement unit 40c are performed on the transmission signal of the transmission voice in the above embodiments, it is also possible to perform the audio signal processing on the reception signal of the reception voice.

While the frequency bandwidth of the input signal is assumed to be 8 kHz in the above embodiments, the frequency bandwidth is not limited to this example; the present invention is applicable also to audio signals of wider bandwidths, for example.

In addition, modification or omission of any component in the embodiments is possible within the scope of the present invention.

### INDUSTRIAL APPLICABILITY

Thus, since it is possible to realize a high-quality voice call (or high-accuracy speech recognition), the hands-free communication device 100 and the acoustic signal processing device 101 according to the present invention are suitable for use for sound quality improvement of voice communication systems, hands-free communication systems, TV conference systems, etc. of car navigation systems, mobile phones, interphones, etc. in which voice communication or a speech recognition system has been introduced, and improvement of the recognition rate of speech recognition systems.

### DESCRIPTION OF REFERENCE CHARACTERS

10, 11: microphone, 12: speaker, 13: receiver, 20: analog-to-digital conversion unit, 21: digital-to-analog conversion unit, 30: acoustic signal analysis unit, 31: acoustic parameter calculation unit, 32: acoustic parameter analysis unit, 33: control signal generation unit, 34: pattern dictionary, 35: control map, 40: acoustic signal correction unit, 40a: echo canceller, 40b: noise canceller, 40c: speech enhancement unit, 70: mobile phone, 80: communication network, 90: mobile phone, 91: landline phone, 92: speech recognition device, 100: hands-free communication device, 101: acoustic signal processing device, 500: near end-side speaker, 501: far end-side speaker.

1. An acoustic signal processing device comprising:
a first storage unit storing first reference data;
a second storage unit storing second reference data;
an acoustic parameter calculation unit to analyze a first acoustic signal of reception voice inputted from a far end side and to generate an analytic acoustic parameter;
an acoustic parameter analysis unit to analyze the analytic acoustic parameter by using the first reference data and thereby generate a parameter analysis result;
a control signal generation unit to generate a control signal for correcting a second acoustic signal of transmission voice inputted from a near end side based on the parameter analysis result by using the second reference data; and
an acoustic signal correction unit to make a correction of the second acoustic signal based on the control signal.

2. The acoustic signal processing device according to claim 1, wherein the acoustic signal correction unit includes an echo canceller that performs an echo cancellation process, as the correction for removing an acoustic echo included in the second acoustic signal, based on the control signal.

3. The acoustic signal processing device according to claim 1, wherein the acoustic signal correction unit includes a noise canceller that performs a noise cancellation process, as the correction for removing noise included in the second acoustic signal, based on the control signal.

4. The acoustic signal processing device according to claim 1, wherein the acoustic signal correction unit includes a speech enhancement unit that performs a speech enhancement process, as the correction for enhancing a feature of speech included in the second acoustic signal, based on the control signal.

5. The acoustic signal processing device according to claim 1, wherein
the acoustic signal correction unit includes an echo canceller that performs an echo cancellation process of removing an acoustic echo included in the second acoustic signal based on the control signal, a noise canceller that performs a noise cancellation process of removing noise included in the second acoustic signal based on the control signal, and a speech enhancement unit that performs a speech enhancement process of enhancing a feature of speech included in the second acoustic signal based on the control signal, and
the acoustic signal correction unit performs control of increasing an echo suppression amount of the echo cancellation process, intensifying the speech enhancement process, and decreasing a noise suppression amount of the noise cancellation process based on the control signal.

6. (canceled)

7. The acoustic signal processing device according to claim 1, wherein the acoustic parameter calculation unit generates the analytic acoustic parameter by calculating an N-th order mel frequency cepstrum coefficient by means of cepstrum analysis where N is a positive integer.

8. The acoustic signal processing device according to claim 4, wherein the speech enhancement process is one of a formant enhancement process of enhancing a component of a speech spectrum having a high spectrum amplitude, a pitch emphasis process of emphasizing harmonic structure of voice, and an equalizer process of changing frequency characteristics of the second acoustic signal.

9. A hands-free communication device comprising:
the acoustic signal processing device according to claim 1;
an analog-to-digital conversion unit to perform analog-to-digital conversion on the second acoustic signal and thereby generates a digital signal; and
a digital-to-analog conversion unit to perform digital-to-analog conversion on the first acoustic signal and thereby generates an analog signal.

10. An acoustic signal processing method comprising:
analyzing a first acoustic signal of reception voice inputted from a far end side and generating an analytic acoustic parameter;
analyzing the analytic acoustic parameter by using first reference data and thereby generating a parameter analysis result;
generating a control signal for correcting a second acoustic signal of transmission voice inputted from a near end side based on the parameter analysis result by using second reference data; and
making a correction of the second acoustic signal based on the control signal.

11. An acoustic signal processing device comprising:
a processor to execute a program; and
a memory to store the program which, when executed by the processor, performs
analyzing a first acoustic signal of reception voice inputted from a far end side and generating an analytic acoustic parameter;
analyzing the analytic acoustic parameter by using first reference data and thereby generating a parameter analysis result;
generating a control signal for correcting a second acoustic signal of transmission voice inputted from a near end side based on the parameter analysis result by using second reference data; and
making a correction of the second acoustic signal based on the control signal.
